(19) United States
(12) Patent Application Publication
(10) Pub. No.: US 2014/0091765 A1
(43) Pub. Date: Apr. 3, 2014

(54) Traveler Charger Kit

(71) Applicant: Hung Hi LAW, Hong Kong (HK)

(72) Inventor: Hung Hi LAW, Hong Kong (HK)

(21) Appl. No.: 13/630,980

(22) Filed: Sep. 28, 2012

(51) Int. Cl. H02J 7/00

(52) U.S. Cl. 320/111; 320/107

(57) ABSTRACT

A traveler charger kit includes a storage housing having an access opening, and a receiving cavity, a charger cover, a charging circuitry, a power input plug provided on the storage housing to electrically connect to the charging circuitry, and a charging terminal received in the receiving cavity and is electrically connected to the charging circuitry. The traveler charger kit is arranged to operate between a carrying mode and a charging mode, wherein in the charging mode, the charging terminal is extended to selectively and electrically connect to at least one electronic device for charging thereof, wherein in the carrying mode, the charging terminal is selectively disposed in the receiving cavity which is detachably covered by the charger cover so as to reduce the traveler charger kit into a compact size for convenient carrying.

### BACKGROUND OF THE PRESENT INVENTION

1. Field of Invention

The present invention relates to a charger, and more particularly to a traveler charger kit which is capable of operating in a carrying mode in which a charging terminal can be stored in a storage housing for ensuring convenient carrying of the charger of the present invention and for preventing the user from forgetting to bring individual charging components while carrying the charger.

2. Description of Related Arts

A conventional charger for an electronic device, such as a charger for a cellular phone, usually comprises a main charger housing having an electric plug provided thereon to electrically connect to an external AC power source, a charging terminal adapted for connecting to the electronic device, and a cable detachably extended between the main charger housing and the charging terminal.

There are several disadvantages related to this type of conventional charger. First, the conventional charger as mentioned above is usually designed for charging a single electronic device. Thus, when the user has several electronic devices, such as a cellular phone, a tablet computer, a digital camera, etc., the user has to utilize a number of chargers for charging them. When the user is at home, the situation is more manageable because when the user needs to charge a particular electronic device, he or she may easily get the corresponding charger. However, the story is completely different when the user needs to carry those electronic devices in a short trip. When the user is traveling, he or she needs to carry the electronic devices as well as all of the corresponding chargers and cables for charging them. When the user needs to carry several electronic devices, it is very easy for him or her to forget to bring one or more cables or chargers. When the user is traveling but forgets to bring the chargers or the cables, the user cannot recharge the corresponding electronic devices and this poses a very inconvenient situation for him or her. In very extreme cases, the user has to purchase a new charger when the electronic device is urgently needed.

Second, even if the user does not forget to bring all the chargers and cables with him or her, the numerous chargers and cables occupy a considerable amount of space in his or her luggage. This is especially true when the user only goes for a short trip and carries a small luggage bag. This problem is not resolved for the user to bring a bigger luggage container because when the luggage container becomes bigger, the user needs to spend a considerable amount of time to locate the corresponding charger and cable from the luggage container. Very often, the chargers and the cables are entangling with each other and it is very inconvenient for the user to disentangle a particular charger and the corresponding cable from the rest of the chargers and cables.

Third, when the user finishes using the chargers and cables while travelling, he or she needs to put all the chargers and cables back to his or her luggage container. Since this is usually performed in a hotel room, it is very common for users to forget to pack some of the chargers or cables back to his or her luggage container. The user may not discover the absence of some of the chargers or cables until the next time he or she wishes to use any of those missing items.

Fourth, even if the user is at home, when he or she has a lot of electronic devices, he or she still needs to look for different chargers and the corresponding cables for recharging those electronic devices. Similarly, when the user finishes charging those electronic devices, the user has to store all the accessories and chargers. Very often, the user does not remember where he put some of these chargers or accessories.

### SUMMARY OF THE PRESENT INVENTION

An object of the present invention is to provide a traveler charger kit which is capable of operating in a carrying mode, wherein at least one terminal member and a charging cable can be neatly stored in a storage housing for ensuring convenient carrying of the charger of the present invention and for preventing the user from forgetting to bring individual charging components while carrying the charger.

Another object of the present invention is to provide a traveler charger kit which is capable of operating in a carrying mode, wherein all the necessary charging accessories, such as terminal members, can be packed in the storage housing and conveniently carried by the user. In other words, the user needs not collect all chargers and cables every time he or she wishes to travel.

Another object of the present invention is to provide a traveler charger kit which is capable of operating in a charging mode for selectively charging a wide variety of electronic devices. In other words, a single traveler charger kit can be used to charge many electronic devices by selecting a corresponding charging terminal.

Another object of the present invention is to provide a traveler charger kit which comprises a built-in USB socket as one of the terminal members so as to provide a convenient charging port for the user.

Another object of the present invention is to provide a traveler charger kit which comprises a charging circuitry which is capable of charging a wide range of electronic devices by acquiring electricity from AC sources of different voltages. Thus, the user needs only to have one single charging device (i.e. the traveler charger kit of the present invention) for charging a wide variety of electronic devices. In addition, the present invention is designed for use in in different countries having different AC voltages.

Another object of the present invention is to provide a traveler charger kit which comprises at least one rechargeable battery for providing electricity to recharge an electronic device. In other words, the present invention can be used as a portable battery wherein all the necessary plugs or adapters required for charging the electronic device are conveniently stored in the storage housing.

In order to accomplish the above objects, the present invention provides a traveler charger kit, comprising:

a storage housing having an access opening, and a receiving cavity communicating with the access opening;

a charger cover detachably attached on the storage housing to selectively open and close the access opening;

a charging circuitry disposed in the receiving cavity of the storage housing;

a power source arrangement supported by the storage housing, wherein the power source arrangement is arranged to acquire electricity from a power source and is electrically connected to the charging circuitry;

a charging cable having a circuit end connected to the charging circuitry, and a charging end normally stored in the receiving cavity of the storage housing; and

a charging terminal detachably connected to the charging end of the charging cable, wherein the traveler charger kit is arranged to operate between a carrying mode and a charging mode, wherein in the charging mode, the charging terminal and the charging cable are extended to selectively and electrically connect to at least one electronic device for charging thereof, wherein in the carrying mode and the charging terminal, the charging cable are selectively disposed in the receiving cavity which is detachably covered by the charger cover so as to reduce the traveler charger kit into a compact size for convenient carrying.

The traveler charger kit further comprises a charging cable having a circuit end connected to the charging circuitry, and a charging end normally stored in the receiving cavity of the storage housing and is connected to the charging terminal.

Moreover, the charging terminal comprises a plurality of terminal members wherein one of the terminal members is detachably connected to the charging end of the charging cable for connecting to an external electronic device for charging thereof.

One of the terminal members comprises a USB socket provided on the charging circuitry, wherein the storage housing further has a charging slot formed on a sidewall thereof, and is aligned with the USB socket when the charging circuitry is mounted in the receiving cavity, so that a user is able to connect the electronic device to the USB socket through the charging slot.

The terminal member connecting to the charging cable comprises a USB plug connected to the charging end of the charging cable, wherein the USB plug and the charging cable are received in the receiving cavity when the traveler charger kit is in the carrying mode, wherein when the traveler charger kit is in the charging mode, the USB plug and the charging cable are arranged to extend out of the storage housing for electrically connecting to an electronic device.

The traveler charger kit further comprises at least one charging adapter normally received in the receiving cavity, wherein the charging adapter is arranged to connect to one of the corresponding terminal members so that the corresponding terminal member and the charging adapter are arranged to extend out of the storage housing for charging the electronic device. The charging adapter comprises an adapter body, a first connection port provided on one end of the adapter body and is arranged to connect to the corresponding terminal member, and a second connection port provided on another end of the adapter body and is arranged to connect to the corresponding electronic device.

The power input plug comprises a plurality of plug assemblies, wherein the storage housing further has a power plug platform formed on an exterior surface thereof, wherein one of the plug assemblies is slidably and detachably attached on the power plug platform so as to detachably attach on the storage housing.

The storage housing further comprises a partitioning wall disposed in the receiving cavity to divide the storage housing into a circuit compartment and a storing compartment, wherein the access opening is divided by the partitioning wall into a circuit opening and a storing opening aligning with the circuit compartment and the storing compartment respectively, wherein the charging circuitry is received in the circuit compartment while the charging cable and one of the terminal members are received in the storing compartment.

On the other hand, the charger cover comprises a first cover member detachably attached on the access opening to selectively cover the circuit opening, and a second cover member detachably attached on the access opening to selectively cover the storing opening, wherein when the traveler charger kit is in the carrying mode, the first cover member and the second cover member are arranged to cover the circuit compartment and the storing compartment.

Each of the plug assemblies comprises a base member and a plurality of connector legs spacedly extended from the base member for inserting into a corresponding external power source, wherein the storage housing further comprises a plurality of connectors provided on the power plug platform for electrically connecting the corresponding plug assembly and the charging circuitry when the plug assembly is detachably mounted on the power plug platform.

As an alternative mode of the present invention, the power input plug comprises a plug conductor having a plurality of conducting portions extended along the storage housing for electrically connecting to an external charging slot of a vehicle, wherein the storage housing has a plurality conducting slots, wherein the conducting portions are exposed to an exterior of the storage housing through the conducting slots for contacting with a charging connector of the vehicle when the power input plug is detachably inserted into the charging slot of the vehicle.

These and other objectives, features, and advantages of the present invention will be further elaborated through the following detailed description, the accompanying drawings, and the claims.

### BRIEF DESCRIPTION OF THE DRAWINGS

FIG. 1 is a perspective view of a traveler charger kit according to a preferred embodiment of the present invention.

FIG. 2 is another perspective view of the traveler charger kit according to the preferred embodiment of the present invention.

FIG. 3 is an exploded perspective view of the traveler charger kit according to the preferred embodiment of the present invention.

FIG. 4 is another exploded perspective view of the traveler charger kit according to the preferred embodiment of the present invention.

FIG. 5 is a first alternative mode of the traveler charger kit according to the preferred embodiment of the present invention.

FIG. 6 is a perspective view of the traveler charger kit according to the first alternative mode of the preferred embodiment of the present invention.

FIG. 7 is an exploded perspective view of the traveler charger kit according to the first alternative mode of the preferred embodiment of the present invention.

FIG. 8 is another exploded perspective view of the traveler charger kit according to the first alternative mode of the preferred embodiment of the present invention.

FIG. 9 is a second alternative mode of the traveler charger kit according to the preferred embodiment of the present invention.

FIG. 10 is a third alternative mode of the traveler charger kit according to the preferred embodiment of the present invention.

### DETAILED DESCRIPTION OF THE PREFERRED EMBODIMENT

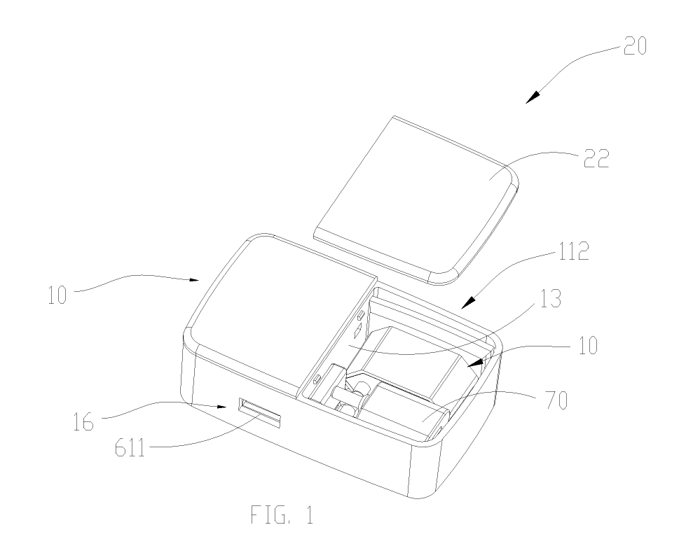

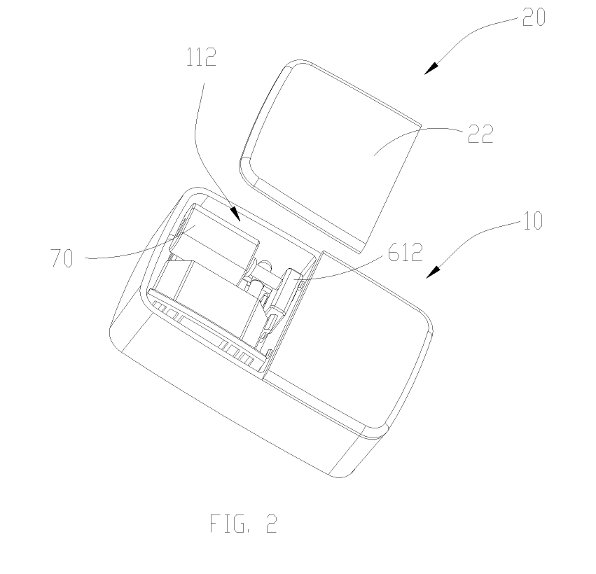

Referring to FIG. 1 to FIG. 4 of the drawings, a traveler charger kit according to a preferred embodiment of the present invention is illustrated, in which the traveler charger kit comprises a storage housing 10, a charger cover 20, a charging circuitry 30, a power source arrangement 100, a charging cable 50, and a charging terminal 60.

The storage housing 10 has an access opening 11, and a receiving cavity 12 communicating with the access opening 11. The charger cover 20 is detachably attached on the storage housing 10 to selectively open and close the access opening 11. The charging circuitry 30 is disposed in the receiving cavity 12 of the storage housing 10.

In this preferred embodiment, the storage housing 10 is rectangular in cross sectional shape and further comprises a partitioning wall 13 disposed in the receiving cavity 12 to divide the storage housing 10 into a circuit compartment 121 and a storing compartment 122. Accordingly, the access opening 11 is also divided by the partitioning wall 13 into a circuit opening 111 and a storing opening 112.

The power source arrangement 100 supported by the storage housing 10 and is arranged to acquire electricity from a power source, which can be an external power source, or an internal power source (which is described in the second alternative mode of the present invention presented below). In this preferred embodiment, the power source arrangement 100 comprises a power input plug 40 provided on the storage housing 10, wherein the power input plug 40 is electrically connected to the charging circuitry 30 for acquiring electricity from an external power source, such as an external AC power source.

According to the preferred embodiment of the present invention, the charger cover 20 comprises a first cover member 21 detachably attached on the access opening 11 to selectively cover the circuit opening 111, and a second cover member 22 detachably attached on the access opening 11 to selectively cover the storing opening 112. Thus, each of the circuit compartment 121 and the storing compartment 122 can be individually covered by the first cover member 21 and the second cover member 22 respectively. When the traveler charger kit is in the carrying mode, the first cover member 21 and the second cover member 22 are arranged to cover the circuit compartment 121 and the storing compartment 122 while the charging cable 50 and the charging terminal 60 are received in the storing compartment 122 so that the entire charging housing 10 can be reduced to a compact size for convenient carrying.

The charging circuitry 30 is arranged to convert an external AC voltage into DC voltage so as to recharge the electronic devices. In order to make the present invention truly convenient for the user, the charging circuitry 30 is arranged to preferably convert a range of external AC voltages (e.g. 110V-240V) into various DC output voltages for allowing the traveler charger kit to be compatible with a wide range of electronic devices.

The power input plug 40 comprises a plurality of plug assemblies 41 which are designed to fit different electric sockets in different countries. For example, one plug assembly 41 is detachably attached on the storage housing 10 and is designed to fit US wall electric socket, while another plug assembly 41 is received in the receiving cavity 12 and is designed to fit electric sockets used in European countries. Thus, the storage housing 10 further has a power plug platform 14 formed on an exterior surface thereof, wherein one of the plug assemblies 41 is slidably and detachably attached on the power plug platform 14 so as to detachably attach on the storage housing 10. When the user carries the traveler charger kit while traveling, he or she can freely attached a suitable plug assembly 41 onto the storage housing 10.

More specifically, each of the plug assemblies 41 comprises a base member 411 and a plurality of connector legs 412 spacedly extended from the base member 411 for inserting into a corresponding AC power socket so as to acquire external AC power supply. The storage housing 10 further comprises a plurality of connectors 15 provided on the power plug platform 14 for electrically connecting the corresponding plug assembly 41 and the charging circuitry 30 when it is detachably mounted on the power plug platform 14.

The charging cable 50 of the traveler charger kit has a circuit end 51 connected to the charging circuitry 30, and a charging end 52 normally stored in the receiving cavity 12 of the storage housing 10.

The charging terminal 60 comprises a plurality of terminal members 61 wherein one of the terminal members 61 (i.e. a first terminal member) is detachably connected to the charging end 52 of the charging cable 50, wherein the traveler charger kit is arranged to operate between a carrying mode and a charging mode, wherein in the charging mode, the charging terminal 60 is extended to selectively and electrically connect to at least one electronic device for charging thereof, wherein in the carrying mode, the charging terminal 60 and the charging cable 50 are selectively disposed in the receiving cavity 12 which is detachably covered by the charger cover 20 so as to reduce the traveler charger kit into a compact size for convenient carrying.

The terminal members 61 of the charging terminal 60 may be embodied as many different types of plugs or sockets for fitting to various types of electronic devices. For example, one of the terminal members 61 is embodied as a USB socket 611 provided on the charging circuitry 30 and is extended to an exterior of the traveler charger kit through the storage housing 10. Accordingly, the storage housing 10 further has a charging slot 16 formed on a sidewall thereof, and is aligned with the USB socket 611 when the charging circuitry 30 is mounted in the circuit compartment 121 of the receiving cavity 12. A user is then able to connect the electronic device to the USB socket 611 through a USB cable and the charging slot 16.

Furthermore, another terminal member 61 (i.e. a second terminal member) may be embodied as a USB plug 612 connected to the charging end 52 of the charging cable 50, wherein the USB plug 612 and the charging cable 50 are received in the storing compartment 122 of the receiving cavity 12 when the traveler charger kit is in the carrying mode. When the traveler charger kit is in the charging mode, the second cover member 22 of the charger cover 20 are opened, and the USB plug 612 and the charging cable 50 are arranged to extend out of the storage housing 10 for electrically connecting to an electronic device.

It is worth mentioning that by separately storing the charging circuitry 30 and the charging cable 50 and the charging terminal 60, each of these components are substantially protected. For example, the user may take the terminal member 61 and the charging cable 50 out of the storing compartment 122 without accessing the circuit compartment 121 so as to prevent the charging circuitry 30 from accidentally damaged.

Moreover, the USB socket 611 or the USB plug 612 can be embodied as a mini USB socket 611 or a mini USB plug 612.

As a result, it is important to mention that the traveler charger kit can be utilized to simultaneously charge two electronic devices by connecting two terminal members 61 to the two electronic devices respectively. A single AC input is all that is required and is acquired from a predetermined plug assembly 41.

One advantage of the traveler charger kit of the present invention is that when it is in the carrying mode, the charging terminal 60 and the charging cable 50 can be stored and received in the storing compartment 122 of the receiving cavity 12 so that the traveler charger kit can be conveniently carried. Most importantly, all the necessary components for charging an electronic device are contained in the storing compartment 122 and the user is prevented from forgetting some of these components. When the user needs to bring several electronic devices with him or her, all the necessary components are in the storing compartment 122.

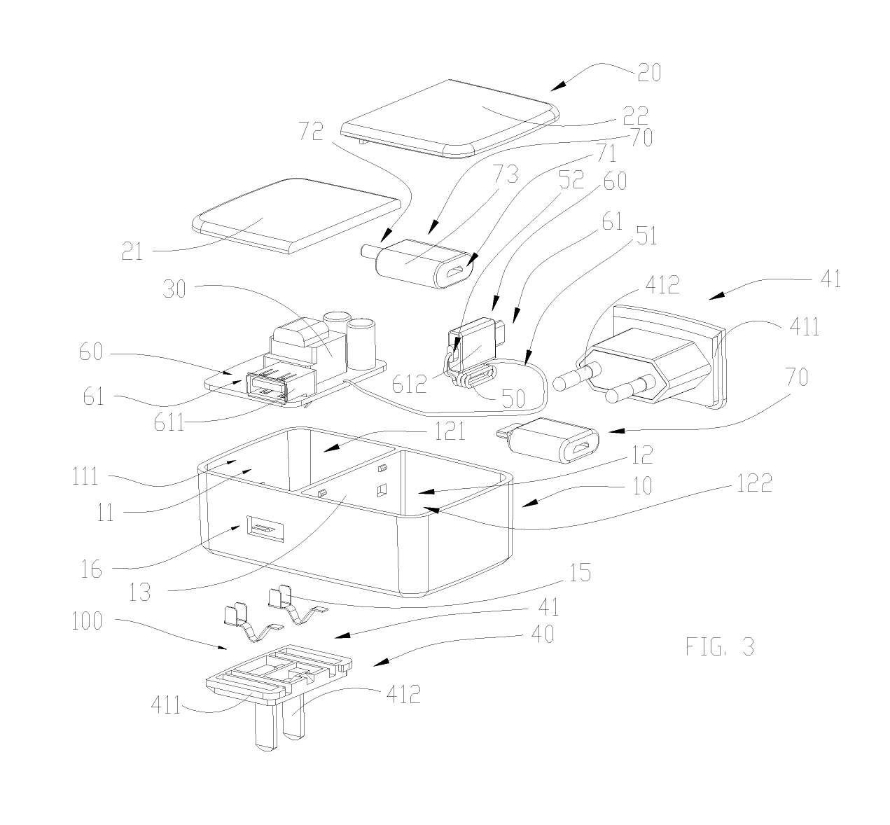

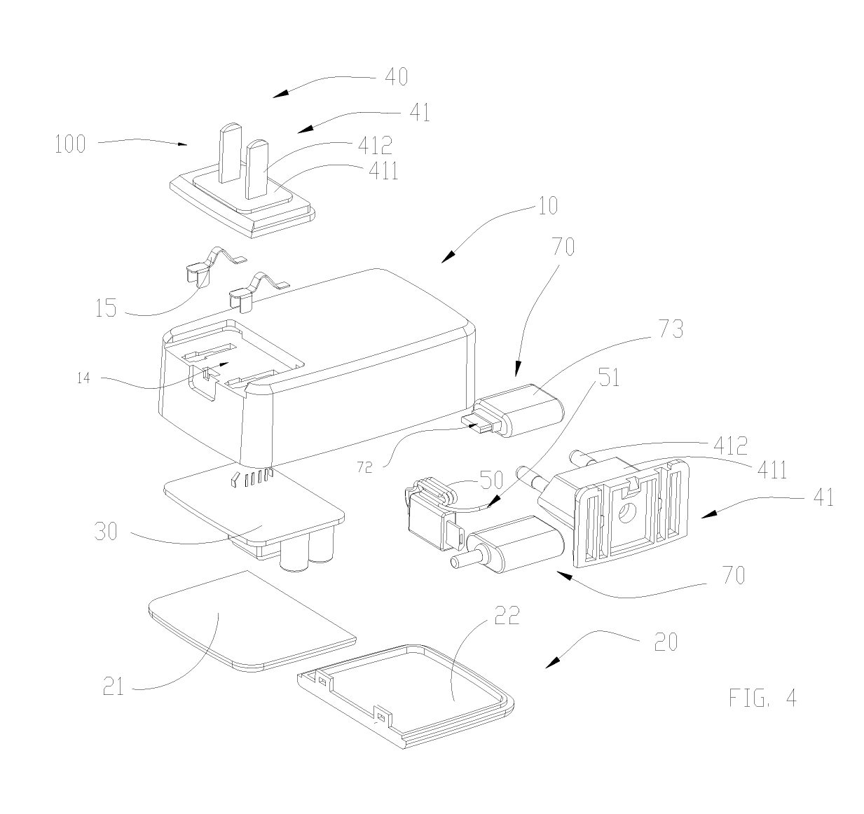

When the traveler charger kit is in the charging mode, the terminal members 61 are arranged to provide built-in or extended charging ports for charging the electronic devices. As mentioned earlier, the present invention can be utilized for simultaneously charging two electronic devices by using two individual terminal members 61. It is important to mention, however, that the terminal members 61 may be embodied as many different charging sockets and plugs, such as those shown in FIG. 3 to FIG. 4 of the drawings (i.e. not only USB socket 611 and the USB plug 612 as mentioned above). Moreover, depending on the size of the storage housing 10, more than two terminal members 61 may be received in the receiving cavity 12.

Since one of the terminal members 61 (i.e. the USB socket 611) is built-in on the charging circuitry 30 and is readily accessible by the user, the user may attach an additional charging cable 50 to the USB socket 611 for charging the electronic device without opening the charger cover 20. This provides fast and convenient charging function for the user of the present invention.

Depending on the manufacturing and marketing circumstances, the traveler charger kit may contain only one terminal member 61 which may be the USB socket 611 or the USB plug 612. Moreover, the traveler charger kit may also contain only one plug assembly 411 which is securely and permanently attached on the storage housing 10. In other words, as long as the traveler charger kit comprises at least one terminal member 61 and at least one plug assembly 411, it falls within the scope of the present invention. It is important to emphasize that one of the objectives of the present invention is to allow the user to put the terminal member 61 into the receiving cavity 12 when it is not in use.

The portable charging kit further comprises a plurality of charging adapters 70 normally received in the storing compartment 122 of the receiving cavity 12, wherein each of the charging adapters 70 is arranged to connect to one of the corresponding terminal members 61 (such as the USB plug 612), wherein the corresponding terminal member 61 and the charging adapter 70 are arranged to extend out of the storage housing 10 for charging a predetermined electronic device.

Hence, the charging adapters 70 are included in the storage housing 10 to provide additional charging options to the user so that the traveler charger kit of the present invention may be used to charge even more electronic devices. For example, when an electronic device does not have a USB-type charging slot, the user may pick a suitable charging adapter 70 and connect it to the corresponding terminal member 61 (i.e. the USB plug 612) so that the electronic device may properly connect to the charging circuitry 30 through the terminal member 61 and the charging adapter 70.

Accordingly, each of the charging adapters 70 comprises an adapter body 73, a first connection port 71 provided on one end of the adapter body 73 and is arranged to connect to the corresponding terminal member 61, and a second connection port 72 provided on another end of the adapter body 73 and is arranged to connect to the corresponding electronic device.

The first connection port 71 is embodied as a connection socket detachably and electrically connected to the corresponding terminal member 61, while the second connection port 72 is embodied as a connection plug adapted for detachably connecting to the electronic device. As a slight alternative, the second connection port 72 can be embodied as a connection socket for electrically and detachably connecting to the electronic device. Depending on marketing and manufacturing circumstances, the exact number of terminal members 61 and the charging adapters 70 can be optimally adjusted for fitting different needs.

The operation of the present invention is as follows: the user may normally store the charging terminal 61 into the storing compartment 122 and the charger cover 20 is arranged to cover the access opening 11. This is when the traveler charger kit is in the carrying mode. In this mode, all the necessary accessories for charging the electronic devices possessed by the user are stored in the storing compartment 122 and when the user carries the traveler charger kit of the present invention, the user is prevented from forgetting any of the necessary charging components. Thus, when the user is travelling, he or she does not need to worry about chargers for his or her electronic devices. A single traveler charger kit can be used to charge all of his or her portable electronic devices, including but not limited to cellular phones, tablet computers, digital cameras, etc.

When the user wishes to charge any of his or her electronic devices, he or she can simply connect the storage hosing 10 to an external AC power source through the power input plug 40. At the same time, the user has two options. First, he or she can simply connect the electronic device to the USB socket 611 of the terminal member 61 provided on the storage housing 10 for directly and immediately charging the electronic device. The second option is that the user may open the second cover member 22 of the charger cover 20 and take out the USB plug 612 of another terminal member 61. The USB plug 612 may be extended from the storage housing 10 through the charging cable 50 and electrically connect to the electronic device.

Since the terminal member 61 and the charging adapter 70 are attached on the storage housing 10 when it was used to charge the electronic device, when the user has finished charging the electronic device, he or she simply needs to place the terminal member 61 and the charging adapter 70 back to the storing compartment 122 of the receiving cavity 12. This user is prevented from forgetting to pick up any charging components. When the terminal member 61 and the charging adapter 70 are placed in the receiving cavity 12, the user needs to close the charger cover 20 and the traveler charger kit is again reduced to a compact size for convenient carrying.

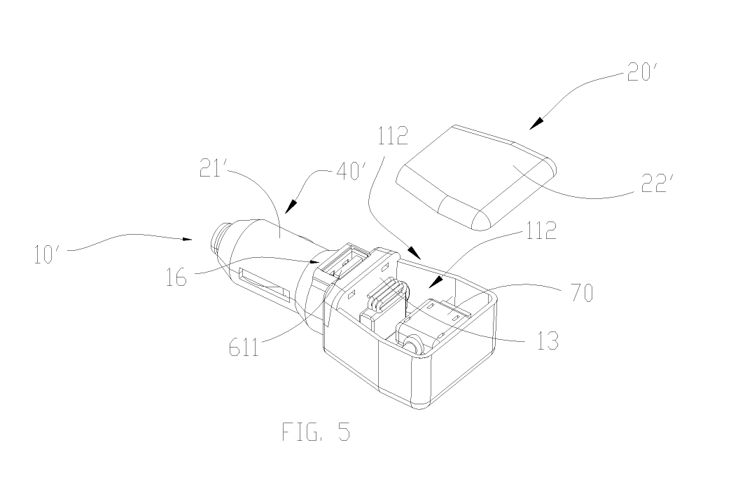

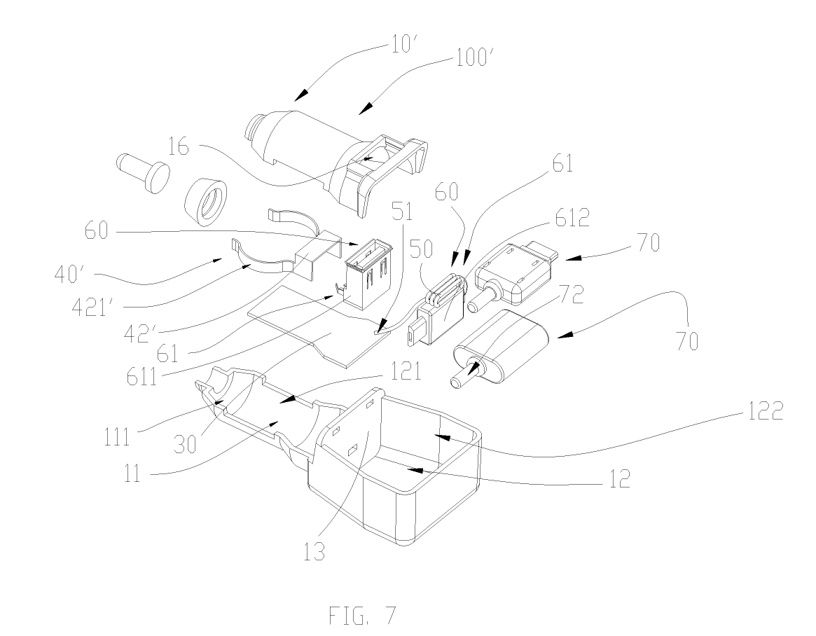

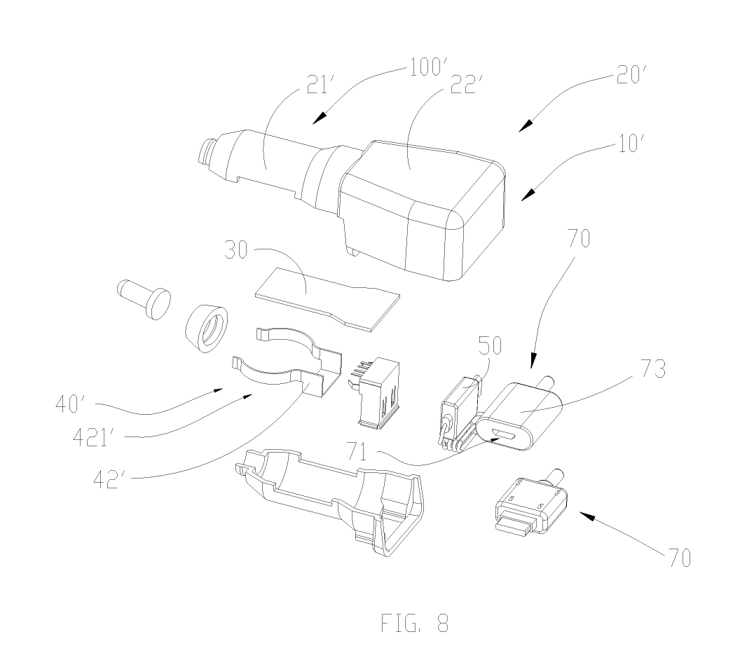

Referring to FIG. 5 to FIG. 8 of the drawings, a first alternative mode of the traveler charger kit according to a preferred embodiment of the present invention is illustrated. The first alternative mode is similar to the preferred embodiment described above, except the shape of the storage housing 10′, the charger cover 20′, and the power input plug 40′ of the power source arrangement 100′.

According to the alternative mode, the power input plug 40′ provided on the circuit compartment 121 is arranged to be inserted into a charging slot of a vehicle so that the traveler charger kit is capable of acquiring electricity from the vehicle. In other words, the present invention in this alternative mode does not acquire external AC power for charging the electronic device. Rather, the traveler charger kit is arranged to acquire DC power from the vehicle for charging the electronic device. Thus, the circuit compartment 121 of the storage hosing 10′ is elongated in shape and has a substantially circular cross section which is adapted for inserting into the charging slot of a vehicle. Moreover, in this alternative mode, the first cover member 21′ is not detachable from the storage housing 10′ while the second cover member 22′ is still detachable from the storage housing 10′.

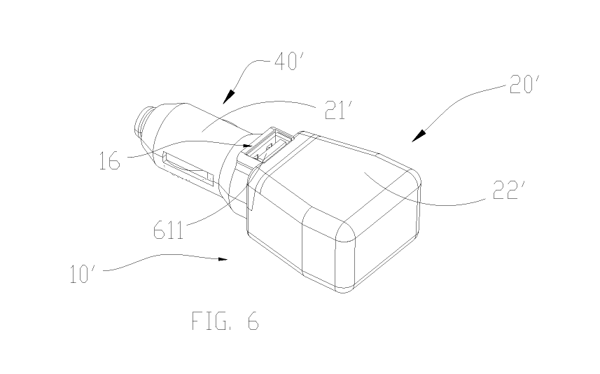

The power input plug 40′ comprises a plug conductor 42′ having a plurality of conducting portions 421′ extended along the circuit compartment 121 of the storage housing 10′ for electrically connecting the charging connector of a vehicle to the charging circuitry 30. As shown in FIG. 6 to FIG. 9 of the drawings, the storage housing 10′ further has a plurality conducting slots 17′, wherein the conducting portions 421′ are curved and exposed to an exterior of the storage housing 10′ through the conducting slots 17′ for contacting with the charging connector of the vehicle when the power input plug 40′ is detachably inserted into a charging socket of that vehicle.

When the power input plug 40′ is connected to the charging socket of the vehicle, the user has the option of charging the electronic device by connecting it to the USB socket 611 of the terminal member 61 provided on the storage housing 10′. Alternatively, the user may open the charger cover 20 and take out the USB plug 611 and the charging adapter 70 from the receiving cavity 12 for connecting to the electronic device for charging thereof. These procedures are similar to what is disclosed in the preferred embodiment above.

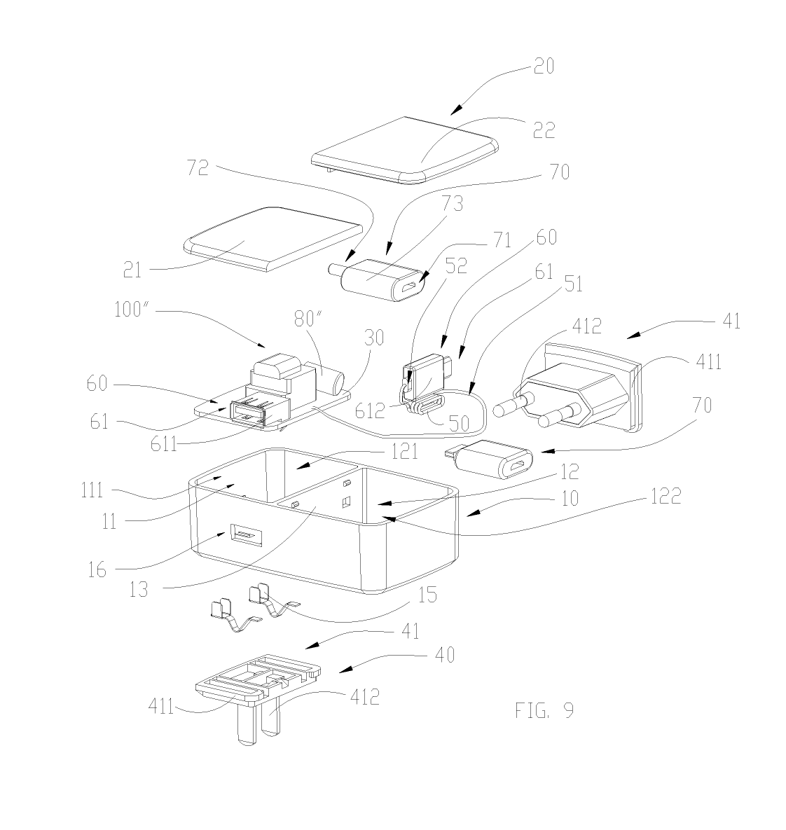

Referring to FIG. 9 of the drawings, a second alternative mode of the traveler charger kit according to a preferred embodiment of the present invention is illustrated. The second alternative mode is similar to the preferred embodiment described above, except that the power source arrangement. In the second alternative mode, the power source arrangement 100″ at least one rechargeable battery 80″ received in the storage housing 10 and electrically connected to the charging circuitry 30 for providing electric power to charge the electronic device.

There exist two options for charging this rechargeable battery 80″. First, the rechargeable battery 80″ can be charged by the power input plug 40 mentioned above. Furthermore, the charging circuitry may acquire electricity from either the power input plug 40 or the rechargeable battery 80″. For example, the charging circuitry 30 can be programmed in such a manner that when the power input plug 40 is connected to an external AC power source, the electronic device is arranged to be charged by acquiring electricity from the AC power source and the acquired electricity can also be used to charge the rechargeable battery 80″. However, when the power input plug 40 is not connected to the AC power source, the electronic device is arranged to be charged by electricity solely acquired from the rechargeable battery 80″. The rechargeable battery is preferably Li-ion battery, yet other rechargeable batteries can also be used.

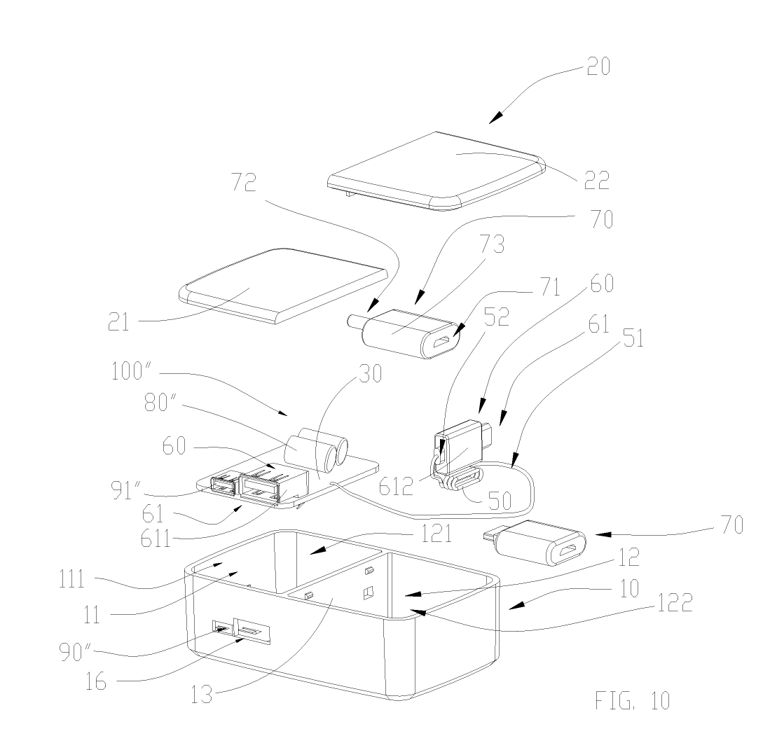

As a third alternative mode of the present invention, as shown in FIG. 10 of the drawings, the rechargeable battery 80″ can also be recharged through a specifically designed charger or a power plug extended from the storage housing 10. In this scenario, the storage housing 10 further has an addition charging slot 90″ provided thereon and is electrically connected to the charging circuitry 30, wherein a user is able to recharge the rechargeable battery 80″ through connecting a predetermined power plug or charger to the additional charging slot 90″. Moreover, the electronic device is solely recharged by the rechargeable battery 80″ and the power input plug 40 described above is absent in this third alternative mode.

The advantage of this third alternative mode of the present invention is that a user may consider the present invention as a portable battery which can be used to recharge the electronic device. Conventional rechargeable batteries require the user to bring the corresponding cables and adapters for recharge of the electronic device. In the present invention, the user does not need to look for individual cables and adapters or plugs. All the plugs and adapters are stored in the storage housing 10 and this prevents the user from forgetting to bring the required accessories for charging the electronic device. Since no AC power source is required, the user may utilized the present invention for charging the electronic device anytime and anyplace he or she wishes.

One skilled in the art will understand that the embodiment of the present invention as shown in the drawings and described above is exemplary only and not intended to be limiting. The embodiments described above are for the purposes of illustrating the functional and structural principles of the present invention and is subject to change without departing from such principles. Therefore, this invention includes all modifications encompassed within the spirit and scope of the following claims.

What is claimed is:

1. A traveler charger kit, comprising:
a storage housing having an access opening, and a receiving cavity communicating with said access opening;
a charger cover detachably attached on said storage housing to selectively open and close said access opening;
a charging circuitry disposed in said receiving cavity of said storage housing;
a power source arrangement supported by said storage housing, wherein said power source arrangement is arranged to acquire electricity from a power source and is electrically connected to said charging circuitry; and
a charging terminal received in said receiving cavity and is electrically connected to said charging circuitry, wherein said traveler charger kit is arranged to operate between a carrying mode and a charging mode, wherein in said charging mode, said charging terminal is extended to selectively and electrically connect to at least one electronic device for charging thereof, wherein in said carrying mode, said charging terminal is selectively disposed in said receiving cavity which is detachably covered by said charger cover so as to reduce said traveler charger kit into a compact size for convenient carrying.

2. The traveler charger kit, as recited in claim 1, further comprising a charging cable having a circuit end connected to said charging circuitry, and a charging end normally stored in said receiving cavity of said storage housing, wherein said charging terminal comprises a first terminal member connected to said charging end of said charging cable for connecting to an external electronic device for charging thereof.

3. The traveler charger kit, as recited in claim 2, wherein said first terminal member comprises a USB plug connected to said charging end of said charging cable, wherein said USB plug and said charging cable are received in said receiving cavity when said traveler charger kit is in said carrying mode, wherein when said traveler charger kit is in said charging mode, said USB plug and said charging cable are arranged to extend out of said storage housing for electrically connecting to an electronic device.

4. The traveler charger kit, as recited in claim 3, wherein said charging terminal further comprises a second terminal member which comprises a USB socket provided on said charging circuitry, wherein said storage housing further has a charging slot formed on a sidewall thereof, and is aligned with said USB socket when said charging circuitry is mounted in said receiving cavity, so that a user is able to connect said electronic device to said USB socket through said charging slot.

5. The traveler charger kit, as recited in claim 4, further comprising at least one charging adapter normally received in said receiving cavity, wherein said charging adapter is arranged to said second terminal member so that said second terminal member and said charging adapter are arranged to extend out of said storage housing for charging said electronic device.

6. The traveler charger kit, as recited in claim 5, wherein said charging adapter comprises an adapter body, a first connection port provided on one end of said adapter body and is arranged to connect to said second terminal member, and a second connection port provided on another end of said adapter body and is arranged to connect to said corresponding electronic device.

7. The traveler charger kit, as recited in claim 6, wherein said power source arrangement comprises a power input plug comprising at least one plug assembly provided on said storage housing.

8. The traveler charger kit, as recited in claim 6, wherein said power source arrangement comprises a power input plug comprising at least one plug assembly provided said storage housing, wherein said storage housing further has a power plug platform formed on an exterior surface thereof, wherein said plug assembly is detachably attached on said power plug platform.

9. The traveler charger kit, as recited in claim 7, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

10. The traveler charger kit, as recited in claim 8, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

11. The traveler charger kit, as recited in claim 9, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

12. The traveler charger kit, as recited in claim 10, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

13. The traveler charger kit, as recited in claim 11, said plug assembly comprises a base member and a plurality of connector legs spacedly extended from said base member for inserting into a corresponding external power source, wherein said storage housing further comprises a plurality of connectors provided on said power plug platform for electrically connecting said corresponding plug assembly and said charging circuitry when said plug assembly is detachably mounted on said power plug platform.

14. The traveler charger kit, as recited in claim 12, wherein said plug assembly comprises a base member and a plurality of connector legs spacedly extended from said base member for inserting into a corresponding external power source, wherein said storage housing further comprises a plurality of connectors provided on said power plug platform for electrically connecting said corresponding plug assembly and said charging circuitry when said plug assembly is detachably mounted on said power plug platform.

15. The traveler charger kit, as recited in claim 6, wherein said power source arrangement comprises a power input plug which comprises a plug conductor having a plurality of conducting portions extended along said storage housing for electrically connecting to an external charging slot of a vehicle, wherein said storage housing has a plurality conducting slots, wherein said conducting portions are exposed to an exterior of said storage housing through said conducting slots for contacting with a charging connector of said vehicle when said power input plug is detachably inserted into said charging slot of said vehicle.

16. The traveler charger kit, as recited in claim 15, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

17. The traveler charger kit, as recited in claim 16, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

18. The traveler charger kit, as recited in claim 1, further comprising a charging cable having a circuit end connected to said charging circuitry, and a charging end normally stored in said receiving cavity of said storage housing, wherein said charging terminal comprises a first terminal member connected to said charging end of said charging cable for connecting to an external electronic device for charging thereof.

19. The traveler charger kit, as recited in claim 18, wherein said first terminal member comprises a USB plug connected to said charging end of said charging cable, wherein said USB plug and said charging cable are received in said receiving cavity when said traveler charger kit is in said carrying mode, wherein when said traveler charger kit is in said charging mode, said USB plug and said charging cable are arranged to extend out of said storage housing for electrically connecting to an electronic device.

20. The traveler charger kit, as recited in claim 19, further comprising at least one charging adapter normally received in said receiving cavity, wherein said charging adapter is arranged to said second terminal member so that said second terminal member and said charging adapter are arranged to extend out of said storage housing for charging said electronic device.

21. The traveler charger kit, as recited in claim 20, wherein said charging adapter comprises an adapter body, a first connection port provided on one end of said adapter body and is arranged to connect to said second terminal member, and a second connection port provided on another end of said adapter body and is arranged to connect to said corresponding electronic device.

22. The traveler charger kit, as recited in claim 21, wherein said power source arrangement comprises a power input plug comprising at least one plug assembly provided on said storage housing.

23. The traveler charger kit, as recited in claim 21, wherein said power source arrangement comprises a power input plug comprising at least one plug assembly provided on said storage housing, wherein said storage housing further has a power plug platform formed on an exterior surface thereof, wherein said plug assembly is detachably attached on said power plug platform.

24. The traveler charger kit, as recited in claim 22, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

25. The traveler charger kit, as recited in claim 23, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

26. The traveler charger kit, as recited in claim 24, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

27. The traveler charger kit, as recited in claim 25, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

28. The traveler charger kit, as recited in claim 26, wherein said plug assembly comprises a base member and a plurality of connector legs spacedly extended from said base member for inserting into a corresponding external power source, wherein said storage housing further comprises a plurality of connectors provided on said power plug platform for electrically connecting said corresponding plug assembly and said charging circuitry.

29. The traveler charger kit, as recited in claim 27, wherein said plug assembly comprises a base member and a plurality of connector legs spacedly extended from said base member for inserting into a corresponding external power source, wherein said storage housing further comprises a plurality of connectors provided on said power plug platform for electrically connecting said corresponding plug assembly and said charging circuitry when said plug assembly is detachably mounted on said power plug platform.

30. The traveler charger kit, as recited in claim 21, wherein said power source arrangement comprises a power input plug which comprises a plug conductor having a plurality of conducting portions extended along said storage housing for electrically connecting to an external charging slot of a vehicle, wherein said storage housing has a plurality conducting slots, wherein said conducting portions are exposed to an exterior of said storage housing through said conducting slots for contacting with a charging connector of said vehicle when said power input plug is detachably inserted into said charging slot of said vehicle.

31. The traveler charger kit, as recited in claim 30, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

32. The traveler charger kit, as recited in claim 31, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

33. The traveler charger kit, as recited in claim 1, wherein said charging terminal comprises a second terminal member which comprises a USB socket provided on said charging circuitry, wherein said storage housing further has a charging slot formed on a sidewall thereof, and is aligned with said USB socket when said charging circuitry is mounted in said receiving cavity, so that a user is able to connect said electronic device to said USB socket through said charging slot.

34. The traveler charger kit, as recited in claim 33, wherein said power source arrangement comprises a power input plug comprising at least one plug assembly provided on said storage housing.

35. The traveler charger kit, as recited in claim 33, wherein said power source arrangement comprises a power input plug comprising at least one plug assembly provided on said storage housing, wherein said storage housing further has a power plug platform formed on an exterior surface thereof, wherein said plug assembly is detachably attached on said power plug platform

36. The traveler charger kit, as recited in claim 34, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

37. The traveler charger kit, as recited in claim 35, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

38. The traveler charger kit, as recited in claim 36, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

39. The traveler charger kit, as recited in claim 37, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

40. The traveler charger kit, as recited in claim 38, wherein said plug assembly comprises a base member and a plurality of connector legs spacedly extended from said base member for inserting into a corresponding external power source, wherein said storage housing further comprises a plurality of connectors provided on said power plug platform for electrically connecting said corresponding plug assembly and said charging circuitry.

41. The traveler charger kit, as recited in claim 39, wherein said plug assembly comprises a base member and a plurality of connector legs spacedly extended from said base member for inserting into a corresponding external power source, wherein said storage housing further comprises a plurality of connectors provided on said power plug platform for electrically connecting said corresponding plug assembly and said charging circuitry when said plug assembly is detachably mounted on said power plug platform.

42. The traveler charger kit, as recited in claim 33, wherein said power source arrangement comprises a power input plug which comprises a plug conductor having a plurality of conducting portions extended along said storage housing for electrically connecting to an external charging slot of a vehicle, wherein said storage housing has a plurality conducting slots, wherein said conducting portions are exposed to an exterior of said storage housing through said conducting slots for contacting with a charging connector of said vehicle when said power input plug is detachably inserted into said charging slot of said vehicle.

43. The traveler charger kit, as recited in claim 42, wherein said storage housing further comprises a partitioning wall disposed in said receiving cavity to divide said storage housing into a circuit compartment and a storing compartment, wherein said access opening is divided by said partitioning wall into a circuit opening and a storing opening aligning with said circuit compartment and said storing compartment respectively, wherein said charging circuitry is received in said circuit compartment while said charging cable and one of said terminal members are received in said storing compartment.

44. The traveler charger kit, as recited in claim 43, wherein said charger cover comprises a first cover member detachably attached on said access opening to selectively cover said circuit opening, and a second cover member detachably attached on said access opening to selectively cover said storing opening, wherein when said traveler charger kit is in said carrying mode, said first cover member and said second cover member are arranged to cover said circuit compartment and said storing compartment.

45. The traveler charger kit, as recited in claim 6, wherein said power source arrangement further comprises at least one rechargeable battery received in said storage housing and electrically connected to said charging circuitry for providing electric power to charge said electronic device.

46. The traveler charger kit, as recited in claim 7, wherein said power source arrangement further comprises at least one rechargeable battery received in said storage housing and electrically connected to said charging circuitry for providing electric power to charge said electronic device.

47. The traveler charger kit, as recited in claim 8, wherein said power source arrangement comprises at least one rechargeable battery received in said storage housing and electrically connected to said charging circuitry for providing electric power to charge said electronic device.

48. The traveler charger kit, as recited in claim 15, wherein said power source arrangement comprises at least one rechargeable battery received in said storage housing and electrically connected to said charging circuitry for providing electric power to charge said electronic device.

49. The traveler charger kit, as recited in claim 21, wherein said power source arrangement comprises at least one rechargeable battery received in said storage housing and electrically connected to said charging circuitry for providing electric power to charge said electronic device.

50. The traveler charger kit, as recited in claim 22, wherein said power source arrangement comprises at least one rechargeable battery received in said storage housing and electrically connected to said charging circuitry for providing electric power to charge said electronic device.

51. The traveler charger kit, as recited in claim 23, wherein said power source arrangement comprises at least one rechargeable battery received in said storage housing and electrically connected to said charging circuitry for providing electric power to charge said electronic device.

52. The traveler charger kit, as recited in claim 30, wherein said power source arrangement comprises at least one rechargeable battery received in said storage housing and electrically connected to said charging circuitry for providing electric power to charge said electronic device.

53. The traveler charger kit, as recited in claim 33, wherein said power source arrangement comprises at least one rechargeable battery received in said storage housing and electrically connected to said charging circuitry for providing electric power to charge said electronic device.

54. The traveler charger kit, as recited in claim 34, wherein said power source arrangement comprises at least one rechargeable battery received in said storage housing and electrically connected to said charging circuitry for providing electric power to charge said electronic device.

55. The traveler charger kit, as recited in claim 35, wherein said power source arrangement comprises at least one rechargeable battery received in said storage housing and electrically connected to said charging circuitry for providing electric power to charge said electronic device.

56. The traveler charger kit, as recited in claim 42, wherein said power source arrangement comprises at least one rechargeable battery received in said storage housing and electrically connected to said charging circuitry for providing electric power to charge said electronic device.
